(19) United States
(12) Patent Application Publication
(10) Pub. No.: US 2020/0312064 A1
(43) Pub. Date: Oct. 1, 2020

(54) AUXILIARY DATA MANAGEMENT SYSTEM THAT PERFORMS VERIFICATION OPERATIONS FOR AGE-RESTRICTED INTERACTIONS WITH AN ESTABLISHMENT

(71) Applicant: The Code Corporation, Draper, UT (US)

(72) Inventors: John Deal, Springfield, PA (US); George Powell, Draper, UT (US)

(21) Appl. No.: 16/363,983

(22) Filed: Mar. 25, 2019

(51) Int. Cl. G07C 9/00; G06Q 30/06; G06Q 30/02; G06K 7/14

(52) U.S. Cl. CPC G07C 9/00031; G06K 7/1413; G06Q 30/0201; G06Q 30/0607

(57) ABSTRACT

Verification operations may be performed in connection with individuals' age-restricted interactions with an establishment. A barcode reading application running on a mobile device may be used to read a barcode on an ID card corresponding to an individual. Personal information associated with the individual may be extracted from the decoded data. The barcode reading application may determine, using the personal information, whether the individual satisfies a minimum age requirement for participating in an age-restricted interaction with an establishment. The barcode reading application may also perform at least one additional function related to the individual's participation or attempted participation in the age-restricted interaction when operating in an enhanced mode of operation.

### BACKGROUND

A barcode is an optical machine-readable representation of information. Devices for identifying or extracting information from barcodes are generally referred to as barcode readers (or barcode scanners).

There are several different types of barcode readers that are commonly used today. For example, one type of barcode reader that is in widespread use is an image-based barcode reader, which includes a camera for capturing an image of a barcode to be read. The camera includes a focusing lens that focuses light reflected from a target area onto a photo sensor array. Once an image of a barcode has been captured by the camera, a decoder processes the image and extracts the information contained in the barcode. An image-based barcode reader may be a standalone device, or it may be a mobile computing device (e.g., a smartphone or tablet computer) that includes a camera and software for reading barcodes.

Barcodes and barcode readers have become widely used in many different types of commercial environments. In addition to being commonly used in point-of-sale stations in retail stores and supermarkets, barcodes and barcode readers are frequently used for many other purposes as well.

For example, barcodes and barcode readers may be used in connection with age verification. From time to time, individuals may want to participate in age-restricted interactions with an establishment. (As used herein, the term “establishment” refers to any store, organization, or institution that provides services and/or products to individuals.) For example, an individual may want to enter an establishment (e.g., a bar or club that serves alcoholic beverages) for which there is a defined minimum age requirement. As another example, an individual may want to purchase a product (e.g., alcoholic beverages, cigarettes) for which there is a defined minimum age requirement.

In order to participate in an age-related interaction with an establishment, the individual may be required to present evidence that the individual satisfies a minimum age requirement. This evidence may be presented in the form of an identification (ID) card that corresponds to the individual. The ID card may include a barcode. The information that is encoded into the barcode may include a birthdate of the individual as well as other information about the individual.

In many cases, however, it would be beneficial to do more than simply perform age verification. For example, in some cases individuals who satisfy a minimum age requirement may nonetheless not be welcome in certain establishments (e.g., due to inappropriate behavior in the past). Simply performing age verification, without more, does not prevent such individuals from re-entering those establishments.

In addition, some jurisdictions have laws that require information about age-restricted interactions with an establishment to be stored for a predetermined period of time, after which such information must be purged. Simply performing age verification, by itself, does not comply with those requirements.

### SUMMARY

The present disclosure is generally related to verification operations that may be performed in connection with individuals' age-restricted interactions with an establishment. For example, in addition to performing age verification, the systems disclosed herein may also enforce a restricted list. The disclosed systems may also collect and analyze auxiliary data related to such age-restricted interactions.

In accordance with one aspect of the present disclosure, a mobile device comprises a camera, one or more processors, memory in electronic communication with the one or more processors, and a barcode reading application stored in the memory. The barcode reading application may be executable by the one or more processors to cause the camera to capture an image that comprises a barcode on an identification (ID) card corresponding to an individual. The barcode reading application may also be executable by the one or more processors to decode the barcode to generate decoded data. The barcode reading application may also be executable by the one or more processors to extract personal information associated with the individual from the decoded data. The barcode reading application may also be executable by the one or more processors to determine, using the personal information, whether the individual satisfies a minimum age requirement for participating in an age-restricted interaction with an establishment. The barcode reading application may also be executable by the one or more processors to perform at least one additional function related to the individual's participation or attempted participation in the age-restricted interaction when operating in an enhanced mode of operation.

In some embodiments, the at least one additional function may comprise using the personal information to determine whether the individual is included on a restricted list that identifies individuals who are to be denied access to the establishment. The restricted list may be stored on a server. Determining whether the individual is included on the restricted list may comprise sending a request to the server. The request may comprise at least some of the personal information that was obtained by reading the barcode on the ID card associated with the individual.

In some embodiments, a local copy of the restricted list may be stored on the mobile device. Determining whether the individual is included on the restricted list may comprise searching records within the local copy of the restricted list for at least some of the personal information that was obtained by reading the barcode on the ID card associated with the individual.

In some embodiments, the at least one additional function may comprise determining auxiliary data corresponding to the individual's participation or attempted participation in the age-restricted interaction and sending the auxiliary data to a server. In embodiments where the age-restricted interaction with the establishment comprises entering the establishment, the auxiliary data may comprise date information indicating a date when the individual entered the establishment. In embodiments where the establishment sells products that are associated with a minimum age requirement and the age-restricted interaction with the establishment comprises purchasing an age-restricted product from the establishment, the auxiliary data may comprise purchase information indicating what the individual purchased from the establishment.

In some embodiments, the barcode reading application may require a license key to operate in the enhanced mode of operation. The barcode reading application may also be executable by the one or more processors to download the license key from a license server.

In some embodiments, the barcode reading application may also be executable by the one or more processors to determine that the individual satisfies the age requirement and output a positive verification result indicating that the individual should be permitted to participate in the age-restricted interaction with the establishment.

In some embodiments, the barcode reading application may also be executable by the one or more processors to determine that the individual does not satisfy the age requirement and output a negative verification result indicating that the individual should not be permitted to participate in the age-restricted interaction with the establishment.

In accordance with another aspect of the present disclosure, a workflow server comprises one or more processors and memory in electronic communication with the one or more processors. A customer interaction log may be stored in the memory. The customer interaction log may comprise information about age-restricted interactions between customers and an establishment. A restricted list may also be stored in the memory. The restricted list may identify individuals who are to be denied access to the establishment. Instructions may also be stored in the memory. The instructions may be executable by the one or more processors to purge records from the customer interaction log after a predetermined time duration.

In some embodiments, the customer interaction log may comprise an entry log. The entry log may include identification information for individuals who have entered the establishment during a most recent time period corresponding to the predetermined time duration. The entry log may also include date information indicating when the individuals entered the establishment.

In some embodiments, the customer interaction log may comprise a purchase log. The purchase log may include identification information corresponding to individuals who have purchased age-restricted products from the establishment during a most recent time period corresponding to the predetermined time duration. The purchase log may also include purchase information indicating what the individuals purchased from the establishment.

In some embodiments, the restricted list may identify individuals who are to be denied at least one of entry to the establishment or access to one or more products that are sold by the establishment.

In some embodiments, the instructions may also be executable by the one or more processors to receive auxiliary data from a plurality of different barcode reading applications running on a plurality of different mobile devices and update the customer interaction log based on the received auxiliary data. At least some of the plurality of barcode reading applications may correspond to different establishments. In such embodiments, records within the customer interaction log may comprise an establishment identifier.

In some embodiments, the instructions may also be executable by the one or more processors to receive a request from a mobile device to determine whether an individual is included on the restricted list. The request may comprise personal information associated with the individual. The instructions may also be executable by the one or more processors to search records within the restricted list for at least some of the personal information associated with the individual, and send a response to the mobile device indicating results of the search.

In accordance with another aspect of the present disclosure, a data aggregation server comprises one or more processors, memory in electronic communication with the one or more processors, and instructions stored in the memory. The instructions may be executable by the one or more processors to receive non-personally identifiable information about age-restricted interactions between individuals and a plurality of establishments. The instructions may also be executable by the one or more processors to aggregate the non-personally identifiable information, thereby creating aggregated information. The instructions may also be executable by the one or more processors to use the aggregated information to determine a metric related to the age-restricted interactions between the individuals and the plurality of establishments. The instructions may also be executable by the one or more processors to provide a statistical report that comprises the metric.

In some embodiments, the non-personally identifiable information about the age-restricted interactions may be received from a plurality of barcode reading applications on a plurality of different mobile devices. At least some of the plurality of different barcode reading applications may correspond to different establishments.

In some embodiments, the statistical report may comprise a visual representation of the metric.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description that follows. Features and advantages of the disclosure may be realized and obtained by means of the systems and methods that are particularly pointed out in the appended claims. Features of the present disclosure will become more fully apparent from the following description and appended claims, or may be learned by the practice of the disclosed subject matter as set forth hereinafter.

### BRIEF DESCRIPTION OF THE DRAWINGS

In order to describe the manner in which the above-recited and other features of the disclosure can be obtained, a more particular description will be rendered by reference to specific embodiments thereof which are illustrated in the appended drawings. For better understanding, the like elements have been designated by like reference numbers throughout the various accompanying figures. Understanding that the drawings depict some example embodiments, the embodiments will be described and explained with additional specificity and detail through the use of the accompanying drawings in which:

FIG. 1 depicts an example of a system in which embodiments of the present disclosure may be utilized.

FIG. 2 illustrates an example of a mobile device that may be used in the system of FIG. 1.

FIG. 3 illustrates an example of a system that performs verification operations in connection with individuals' age-restricted interactions with an establishment.

FIG. 4 illustrates an example of the types of communication that may occur between a mobile device and a workflow server in order to determine whether an individual is included on a restricted list.

FIG. 5 illustrates an example of a system in which a workflow server receives auxiliary data from a plurality of barcode reading applications and updates a purchase log.

FIG. 6 illustrates an example of a system in which a workflow server receives auxiliary data from a plurality of barcode reading applications and updates an entry log, and a data aggregation server receives non-personally identifiable information from the plurality of barcode reading applications.

FIG. 7 illustrates an example of a visual representation of a metric that may be created by a data aggregation server and included in a statistical report.

FIG. 8 illustrates an example of a system in which auxiliary data from a plurality of establishments is pooled for purposes of data aggregation.

FIGS. 9A-C illustrate an example of a user interface that may be displayed by a barcode reading application on a mobile device in accordance with the present disclosure.

FIG. 10 illustrates an example of a method that may be implemented by a barcode-reading application running on a mobile device in accordance with the present disclosure.

FIG. 10A illustrates another example of a method that may be implemented by a barcode-reading application running on a mobile device in accordance with the present disclosure.

FIG. 11 illustrates an example of a method that may be implemented by a workflow server in accordance with the present disclosure.

FIG. 12 illustrates another example of a method that may be implemented by a workflow server in accordance with the present disclosure.

FIG. 13 illustrates certain components that may be included within a workflow server in accordance with the present disclosure.

FIG. 14 illustrates a method that may be implemented by a data aggregation server in accordance with the present disclosure.

FIG. 15 illustrates certain components that may be included within a data aggregation server in accordance with the present disclosure.

### DETAILED DESCRIPTION

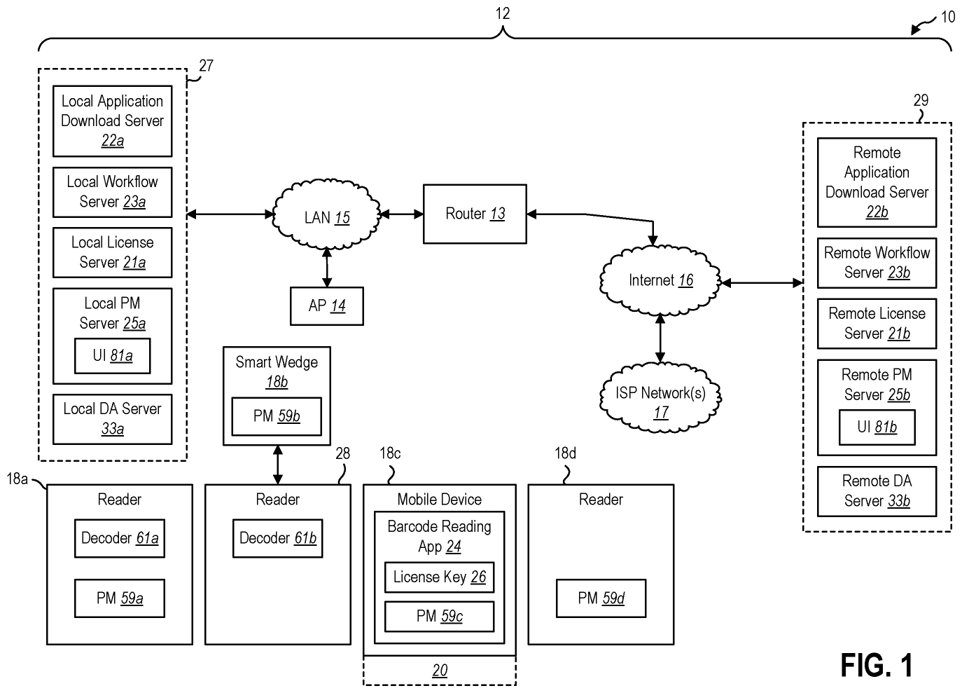

FIG. 1 depicts an example of a system 10 in which embodiments of the present disclosure may be utilized. The system 10 includes process management input devices 18a-d. At least some of the process management input devices 18a-d may include barcode reading functionality and may be configured to read barcodes and provide decoded data to workflow servers 23a-b. In conjunction with reading barcodes, the process management input devices 18a-d may also generate auxiliary data for auxiliary process management systems 25a-25b and/or aggregation systems 33a-33b.

The workflow servers 23a-b include a local workflow server 23a and a remote workflow server 23b. The workflow servers 23a-b may be configured to use decoded data received from the process management input devices 18a-d to track, manage, and document a workflow process.

In one embodiment, the workflow servers 23a-b may support a retail sales workflow wherein a barcode reader attached to a point-of-sale (POS) system may be used to identify products being purchased by reading barcodes (e.g., Universal Product Code (UPC) barcodes) associated with the products. The workflow servers 23a-b may be used to determine price information associated with products, track inventory of products, automate ordering of new products, etc. As just one example, the data within a particular barcode may include a product identifier (ID) for the corresponding product. The barcode reader may send the product ID to a workflow server. Upon receiving the product ID, the workflow server may look up the product price for the POS system to complete the sale.

In one embodiment, the workflow servers 23a-b may be part of a hospital or other healthcare provider's electronic health record system. Data within barcodes on equipment, consumables, medications, and/or patient wristbands may be used to record medical operations such as disbursement of medications and use of equipment and/or consumables within the electronic health record systems.

In one embodiment, the workflow servers 23a-b may be part of a manufacturer's assembly line. Data within barcodes on components may be read and used to identify components (e.g., by a part number common across all components or by a serial number identifying each component individually), track inventory, associate components with final assemblies, etc.

In one embodiment, the workflow servers 23a-b may be part of a provider's system for verifying the age of purchasers of age restricted items such as alcohol or tobacco products. A barcode on an individual's ID card may be read for verification of the individual's age and the workflow servers 23a-b may retain certain identification information for the duration of time required by applicable law.

The process management servers 25a-25b include a local process management server 25a and a remote process management server 25b. The process management servers 25a-25b may use: i) certain portions of the data encoded in, and read from, the barcodes; and/or ii) auxiliary data generated during the process of reading the barcodes to evaluate and improve efficiency of the workflow.

The data aggregation servers 33a-33b include a local data aggregation server 33a and a remote data aggregation server 33b. The data aggregation servers 33a-33b may use: i) certain portions of the data encoded in, and read from, the barcodes; and/or ii) auxiliary data generated during the process of reading the barcodes to aggregate non-personally identifiable statistical data regarding the workflow or multiple workflows.

In one embodiment, the process management servers 23a-b and/or data aggregation servers 25a-25b may obtain information about the quality of each barcode being read (e.g., print quality). This quality information may be aggregated and statistics may be calculated. Upon reviewing these statistics, certain information or trends may become apparent. For example, it may become apparent that certain products have better printed barcodes than other products or that the quality of printing is deteriorating over time on a certain barcode.

In a related embodiment, the process management servers 25a-b and/or data aggregation servers 33a-b may obtain information about the quality of each barcode being read by multiple barcode readers. As such quality information is aggregated and statistics are calculated, it may become apparent that certain barcodes appear to be of better quality in one reader over another reader so that it can be concluded that one reader is capturing clearer images. The reader that is capturing the less clear images may be checked for damage such as a scratched or dirty imaging window.

In one embodiment, the process management servers 25a-b may track the location of each replaceable battery pack used on barcode readers or other data capture devices as part of the workflow. The age and diminished health (e.g., diminished charge capacity) may be tracked.

In one embodiment, the process management servers 25a-b and/or data aggregation servers 33a-b may track metadata associated with each barcode read. The metadata may be analyzed and used for measuring efficiency of the workflow and/or equipment or individuals participating in the workflow. Metadata may include location of the barcode read, the user of the barcode reader, a timestamp of the barcode read, etc.

The system 10 includes a network 12 via which barcode data and the auxiliary data are provided from the process management input devices 18a-d to the applicable workflow servers 23a-b, process management servers 25a-25b, and data aggregation servers 33a-33b. The network 12 may be expansive including one or more local area networks (LAN) 15, the Internet 16, and one or more wired or wireless Internet service provider (ISP) networks 17.

Each LAN 15 may use any known network technologies such as Ethernet and TCP/IP protocols to interconnect various systems. Each LAN 15 may further include at least one wireless access point 14 enabling wireless LAN communications with various systems utilizing known technologies such as Wi-Fi™ (IEEE 802.11).

The system 10 shown in FIG. 1 includes a single LAN 15. The LAN 15 may be coupled to the Internet 16 via a router 13. Although FIG. 1 depicts the LAN 15 coupled to the Internet 16 via a single router 13, such connections may employ multiple routers and firewall systems, including demilitarized zone (DMZ) networks.

For purposes of illustration, the systems interconnected by the LAN 15 may include the local workflow server 23a, the local process management server 25a, the local data aggregation server 33a, and various process management input devices 18a-d.

Coupling the LAN 15 to the Internet 16 enables the system 10 to include and interconnect remote workflow server(s) 23b, remote process management server(s) 25b, remote data aggregation server(s) 33b, and various other process management input devices 18a-d via one or more wired or wireless ISP networks 17.

The remote devices (e.g., devices coupled to the Internet 16) may be logically connected to the LAN 15 using Virtual Private Network (VPN) technology. As such, a mobile device (e.g., mobile device 18d) coupled to communicate with the wireless ISP network 17 utilizing WAN communications may, utilizing a VPN technology, be an endpoint on the LAN 15.

The process management input devices 18a-d may include combinations of smart barcode readers 18a, smart wedges 18b, mobile devices 18c, and non-barcode reading process data input devices 18d. Each of the process management input devices 18a-d may be configured to perform one or more process management operations. The process management operations may include determining auxiliary data corresponding to a workflow process. The auxiliary data may include metadata that is generated in connection with reading one or more barcodes during the workflow process. The process management operations may also include sending the auxiliary data to one or more servers, such as the process management servers 25a-25b and/or the data aggregation servers 33a-33b. To enable the process management input devices 18a-d to perform process management operations, each of the process management input devices 18a-d may include code (which may be referred to herein as process management code) that is stored in memory and executable by one or more processors to perform process management operations.

In general, a smart barcode reader 18a may be configured to perform process management operations in addition to having barcode reading capability. In other words, in addition to reading barcodes and outputting decoded data for the workflow servers 23a-b, a smart barcode reader 18a may also be configured to generate auxiliary data for use by the process management servers 25a-25b and/or data aggregation servers 33a-33b. In addition to a decoder 61a, the smart barcode reader 18a is also shown with process management code 59a that enables the smart barcode reader 18a to perform process management operations.

In general, a smart wedge device 18b is configured to be connected to a traditional barcode reader 28 that is not capable of performing process management operations. The smart wedge device 18b may be configured to perform one or more process management operations related to the barcode reading operations that are performed by the barcode reader 28. For example, a smart wedge device 18b may be configured to: i) couple to, and receive decoded barcode data from, a traditional barcode reader 28; ii) forward the decoded data to the applicable workflow server; iii) generate auxiliary data in relation to the forwarded decoded data; and iv) provide a combination of portions of the decoded data and/or the auxiliary data to one or more of the process management servers 25a-25b and/or data aggregation servers 33a-33b. In FIG. 1, the traditional barcode reader 28 is shown with a decoder 61b, and the smart wedge device 18b is shown with process management code 59b.

The term “mobile device,” as the term is used in this patent specification and the accompanying claims, will be used to describe a portable, hand-held computing device. A mobile device may include a camera. Some examples of mobile devices include smartphones, tablet computers, and hybrid tablet/smartphone devices (which are often nicknamed “phablets”).

A mobile device 18c may include a barcode reading application 24 that enables the mobile device 18c to perform barcode reading operations. For example, the barcode reading application 24 may utilize a camera of the mobile device 18c to capture an image of a barcode. The barcode reading application 24 may also include a decoder that processes the captured image in order to decode the barcode. In addition to performing barcode reading operations, the barcode reading application 24 may also be configured to perform one or more process management operations. FIG. 1 shows the barcode reading application 24 with process management code 59c for providing this functionality. In operation, the barcode reading application 24 may i) utilize a camera of the mobile device 18c to read barcodes; ii) provide the decoded data to the applicable workflow server; iii) generate auxiliary data in relation to the barcode read and/or in relation to the decoded data; and iv) provide a combination of portions of the decoded data and/or the auxiliary data to one or more of the process management servers 25a-b and/or data aggregation servers 33a-33b.

In general, a non-barcode reading process management input device 18d does not have barcode reading capability but is capable of performing process management operations. For example, the non-barcode reading process management input device 18d may be configured to generate auxiliary data in relation to the workflow and provide the auxiliary data to one or more of the process management servers 25a-25b and/or data aggregation servers 33a-33b. The auxiliary data generated by a non-barcode reading process management input device 18d may: i) relate to the workflow in which other process management input devices 18a-18c provide decoded barcode data as part of the workflow; and/or ii) relate to the barcode data read by the other process management input devices 18a-18c as part of the workflow.

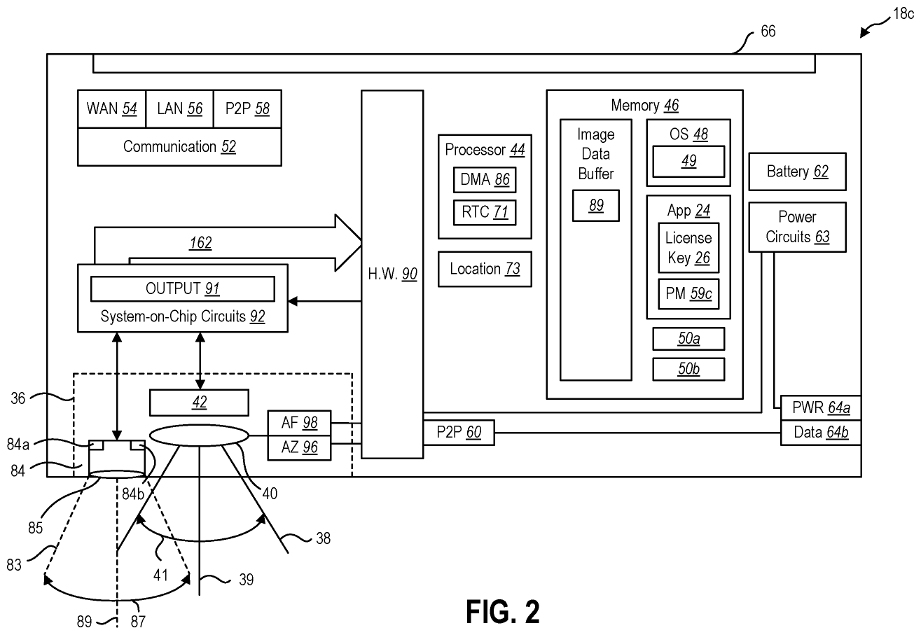

FIG. 2 illustrates an example of a mobile device 18c that may be used in the system 10 of FIG. 1. Referring to FIG. 2 in conjunction with FIG. 1, each mobile device 18c may include a wireless communication system 52 for operating within a wireless network environment. The wireless communication system 52 may comprise any permutation of: i) a local area network (LAN) communications module 56, ii) a wide area network (WAN) communications module 54, and/or iii) a wireless point-to-point communication interface 58.

The LAN communications module 56 may utilize one or more wireless local area communication protocols for communication with a wireless access point 14 of a wireless portion of a LAN 15. The mobile device 18c itself may be an addressable endpoint on the LAN 15. In other words, the mobile device 18c may be assigned an IP address and may be capable of IP communications with other devices over the LAN 15 using IP protocols such as Transmission Connection Protocol (TCP), Uniform Datagram Protocol (UDP), etc. The wireless access point 14 and the LAN communications module 56 may function in accordance with any known wireless communications protocol(s), including but not limited to the IEEE 802.11 standards, which are sometimes referred to as Wi-Fi™.

The WAN communications module 54 may utilize Wideband Code Division Multiple Access (WCDMA), High Speed Packet Access (HSPA), cdma2000, Long Term Evolution (LTE) technology, or other similar long-range wireless communication protocols for communication with a wide area wireless Internet service provider (ISP). For example, the ISP may be a mobile telephone service provider and the wireless WAN communications module 54 may be a system for wireless data communications with the access towers of the wireless ISP network 17 (i.e., WAN). Such wireless data communications may occur in accordance with any suitable wireless communication standard, including Third Generation (3G) standards (e.g., Universal Mobile Telecommunication Systems (UMTS), cdma2000, Enhanced Data Rate for GSM Evolution (EDGE)), Fourth Generation (4G) standards (e.g., LTE, Mobile WiMAX), Fifth Generation (5G) standards, and/or subsequently developed standards. The wireless ISP network 17 may assign an IP address to the mobile device 18c such that the mobile device 18c may be capable of IP communications with other devices over the wireless ISP network 17 using IP protocols such as TCP, UDP, or the like.

The mobile device 18c may include a processor 44 and memory 46 in electronic communication with the processor 44. The processor 44 may be embodied as a combination of one or more microprocessors, microcontrollers, digital signal processors (DSP), or the like. When operating, the processor 44 may execute instructions (in the form of an operating system 48 and/or applications) stored in the memory 46. The memory 46 may be any component capable of storing electronic information (including an operating system 48 and/or application instructions executable by the processor 44), and may be embodied as read-only memory (ROM), random access memory (RAM), magnetic disk storage media, optical storage media, flash memory devices, on-board memory included with the processor 44, erasable programmable read-only memory (EPROM), electrically erasable programmable read-only memory (EEPROM), and/or registers, etc.

The memory 46 may include an operating system 48, a barcode-reading application 24 (which may include a process management module 59c and a license key 26), one or more other applications 50a, 50b, and a data buffer including an image data buffer 89.

In operation, the processor 44 may execute instructions embodied in the operating system 48, the barcode-reading application 24, and each of the other applications 50a, 50b. The processor 44 may further include a real-time clock 71 to enable the mobile device 18c to determine the time at which a barcode is read.

Hardware circuits 90 interface the processor 44 with peripheral systems including, but not limited to, a (multi-touch) display screen 66, a wireless communication system 52, a hardwired point-to-point communication interface 60, a camera 36, and other peripheral systems, including auxiliary data input systems such as a GPS location system 73 or other system for determining the location of the mobile device 18c.

The hardwired point-to-point communication interface 60 may utilize Universal Asynchronous Receiver/Transmitter (UART), Universal Serial Bus (USB), and similar communication protocols for communicating with a compatible system connected to a data connector 64b (which may be a part of a single power/data connector such as a USB connector or an Apple® Lightning Connector®).

The camera 36 may include a (color) image sensor 42 (i.e., an array of photosensitive elements). The image sensor 42 may be positioned parallel to each of the face surface and the back surface of the mobile device 18. The camera 36 may also include a lens assembly 40 with an optical axis 39 orthogonal to the image sensor 42 and defining a center line of a camera field of view 38 extending outward from the back surface of the mobile device 18. The image sensor 42 may take the form of a charge-coupled display (CCD) image sensor, a complementary metal-oxide-semiconductor (CMOS) image sensor, or the like.

The lens assembly 40 may receive light reflected from objects within the field of view 38 of the camera 36, which may be referred to herein as the camera field of view 38. The camera field of view 38 may have an angular size 41 which may be the angle at which the camera field of view 38 spreads with respect to distance from the lens assembly 40. The lens assembly 40 may have a camera aperture size measured as an f-number, which is the ratio of the focal length of the lens assembly 40 to the diameter of the entrance pupil (i.e., the lens aperture (an aperture stop or an inherent aperture of the lens component defining the aperture) as viewed through the front of the lens assembly 40).

The camera 36 may further include an auto zoom module 96 and/or an autofocus module 98 which may serve to control an optical zoom setting and/or autofocus setting of the camera, respectively. Autofocus and auto zoom may be controlled by moving the position of at least one of the lenses making up the lens assembly 40 with respect to each other (or with respect to the image sensor 42) and/or altering the curvature of at least one of the lenses making up the lens assembly 40.

In general, the camera lens assembly 40 and the autofocus module 98 (which compensates for limited depth of field at larger apertures) and the auto zoom module 96 (which adjusts the angular size 41 and image magnification) are designed and/or optimized for general-purpose photography, and may therefore not be ideal for barcode capture and/or decoding. More specifically, in a barcode-reading application an operator expects to read and decode a barcode in less than 300 ms. The focus and zoom adjustment process may require significantly more time and therefore, if used, it would significantly delay the response time in a barcode-reading application.

If the camera lens assembly 40 is fixed (e.g., not adjusted for focus and zoom) at any particular focus and/or zoom setting for the lens assembly 40, the combination of the angular size 41 and the camera aperture size affect the camera depth of field (e.g., the range of distances at which a barcode of a particular modular size is imaged onto the photo sensor with sufficient size and sharpness for decoding). The angular size 41 affects the minimum distance at which a barcode of a certain overall size can be imaged onto the image sensor 42.

The image sensor 42 may be coupled to system-on-chip control circuits 92. In one embodiment, the control circuits 92 may control the operation of the image sensor 42 (e.g., exposure, gain, and coupling of pixels to analog-to-digital (A/D) converters for image read out), format the digital intensity values of each pixel of the image sensor 42 for color image output, and make the color image output available for writing to the image data buffer 89.

In another embodiment, the control circuits 92 may include output module 91 which may perform image processing on images captured by the image sensor 42. Control of the image sensor 42 and image pre-processing that may be performed by the system on chip circuits 92 are described in more detail in U.S. patent application Ser. No. 14/717,112, titled “BARCODE READER” and filed on May 20, 2015, having attorney reference number 3271-2-071, which is hereby incorporated by reference in its entirety (hereinafter, the “'112 Application”). As such, the digital image output 162 (which may be the color image or a result of processing the image one or more times in accordance with the teachings of the '112 Application) may be written to the image data buffer 89. The mobile device 18c may include a direct memory access (DMA) system 86 which may be a part of the processor 44. The DMA system 86 provides for direct writing of the digital image output 162 from the camera 36 to the image data buffer 89.

The camera 36 may further include a white light source 84. The white light source 84 may include one or more LEDs 84a, 84b controlled by the system-on-chip circuits 92.

In an exemplary embodiment, a first LED 84a may be a white LED. The color of a white LED is typically described using a Kelvin temperature scale with 1500 K representing a warm color “white,” such as that of candlelight, and 9500 K representing a cool color “white,” such as that of a blue sky. The exemplary white LED may be within this range. Alternatively, the exemplary white LED may have a color between 4000 K and 7000 K.

In the exemplary embodiment the second LED 84b may be an amber LED emitting illumination within the 600-615 nm range. Both the first LED 84a and the second LED 84b may be positioned behind a common optic 85 which directs illumination within a field of illumination 83 projecting away from the back surface and having an illumination axis perpendicular to the back surface and an illumination angle 87 which substantially coincides with the field of view 38 of the camera 36. In operation, the system-on-chip circuits 92 may control each LED 84a, 84b independently. The system-on-chip circuits 92 may also control the intensity of each LED 84a, 84b independently such that the color of the white illumination of the combined LEDs may be controlled by controlling the intensity of the amber LED with respect to the intensity of the white LED. If the intensity of the amber LED is higher, the white color of the combination will be warmer (lower Kelvin temperature). If the intensity of the amber LED is lower, the color approaches the Kelvin temperature of the white LED alone.

The mobile device 18c may further include a battery 62 and power circuits 63. In general the power circuits 63 control charging of the battery 62 from power received from an external power source via the power connector 64a. The power circuits 63 also provide operating power at the voltage and current drawing requirements of the various components of the mobile device 18c from the power received from the battery 62 or the external power source (when connected to the external power source).

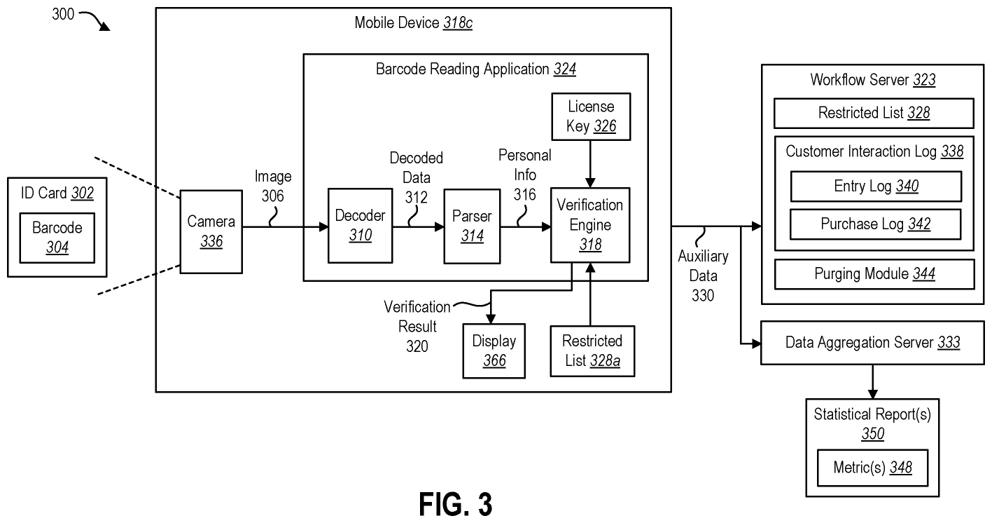

FIG. 3 illustrates an example of a system 300 that performs verification operations in connection with individuals' age-restricted interactions with an establishment.

As discussed above, in order to participate in an age-related interaction with an establishment, an individual may be required to present evidence that the individual satisfies a minimum age requirement. This evidence may be presented in the form of an ID card 302 that corresponds to the individual. The ID card 302 may include a barcode 304. The information that is encoded into the barcode 304 may include a birthdate of the individual as well as other information about the individual.

A mobile device 318c may be used to read the barcode 304 on the ID card 302 in order to verify that the individual satisfies the minimum age requirement. The mobile device 318c may include a barcode reading application 324 that is configured to perform age verification (among other things). The mobile device 318c may download the barcode reading application 324 from a download server, such as either of the download servers 22a-b that were described above in connection with the system 10 shown in FIG. 1.

The mobile device 318c may include a camera 336, which may be similar to the camera 36 that was described previously in connection with FIG. 2. The ID card 302 may be positioned within the field of view of the camera 336, and the barcode reading application 324 on the mobile device 318c may cause the camera 336 to capture an image 306 that includes the barcode 304 on the ID card 302. This image 306 may be captured in response to input provided by a user of the mobile device 318c.

The barcode reading application 324 includes a decoder 310 that processes the image 306 to decode the barcode 304, thereby generating decoded data 312. The barcode reading application 324 also includes a parser 314 that extracts personal information 316 (e.g., a birthdate) associated with the individual from the decoded data 312.

The barcode reading application 324 also includes a verification engine 318 that determines, using the personal information 316, whether the individual satisfies the minimum age requirement for participating in the age-related interaction with the establishment. For example, if the age-related interaction with the establishment involves purchasing alcoholic beverages and the minimum age requirement is twenty one years (as it currently is throughout the United States, for example), the verification engine 318 may compare the individual's birthdate (which may be included within the personal information 316) with a target date that is twenty one years earlier than the current date. If the individual's birthdate is earlier in time than the target date or equal to the target date, then the minimum age requirement is satisfied. If, however, the individual's birthdate is later in time than the target date, then the minimum age requirement is not satisfied.

The barcode reading application 324 may output a verification result 320 that indicates whether or not the individual satisfies the minimum age requirement. If the verification engine 318 determines that the individual satisfies the minimum age requirement, then the verification result 320 may be a positive verification result indicating that the individual should be permitted to participate in the age-related interaction with the establishment. If, however, the verification engine 318 determines that the individual does not satisfy the minimum age requirement, then the verification result 320 may be a negative verification result indicating that the individual should not be permitted to participate in the age-related interaction with the establishment.

In some embodiments, a visual representation of the verification result 320 may be displayed by the mobile device 318c. FIG. 3 shows the verification engine 318 outputting the verification result 320 to a display 366 of the mobile device 318c.

In some embodiments, the verification result 320 may depend on both (i) the result of age verification, and (ii) whether the individual is on a restricted list 328. For example, if the verification engine 318 determines that the individual satisfies the minimum age requirement and also that the individual is not on a restricted list 328, then the verification result 320 may be a positive verification result. Otherwise, the verification result 320 may be a negative verification result. This will be discussed in greater detail below.

The barcode reading application 324 may include at least two different modes of operation: a standard mode of operation and an enhanced mode of operation. A license key 326 may be required for the barcode reading application 324 to operate in the enhanced mode of operation. The barcode reading application 324 may operate in the standard mode of operation without a license key 326. The barcode reading application 324 may download the license key 326 from a license server, such as either of the license servers 21a-b in the system 10 shown in FIG. 1. Before downloading the license key 326, the barcode reading application 324 may require the user to purchase the license key 326 or present evidence that the license key 326 has previously been purchased.

The barcode reading application 324 may include a certain amount of functionality while operating in the standard mode of operation. However, the barcode reading application 324 may provide additional functionality while operating in the enhanced mode of operation.

For example, when operating in the standard mode of operation, the barcode reading application 324 may verify that an individual satisfies a minimum age requirement for participating in an age-related interaction with the establishment, as described above. When operating in the enhanced mode of operation, however, the barcode reading application 324 may perform at least one additional function related to the individual's participation or attempted participation in the age-restricted interaction.

In some embodiments, the additional function(s) that the barcode reading application 324 performs in the enhanced mode of operation may include using the personal information 316 to determine whether the individual is included on a restricted list 328. A restricted list 328 associated with an establishment may identify individuals who are to be denied entry to the establishment. The individuals may be denied entry to the establishment for reasons other than age restrictions. For example, the owner of an establishment may decide that certain individuals should not be permitted to enter the establishment because of past inappropriate behavior on the part of those individuals.

Alternatively, or in addition, a restricted list 328 may identify individuals who are to be denied access to one or more products that are sold by the establishment. The individuals may be denied access to such products for reasons other than age restrictions (e.g., past inappropriate behavior).

The restricted list 328 may be stored on a server that is separate from the mobile device 318c. For example, in some embodiments, the restricted list 328 may be stored on a workflow server 333. Alternatively, or in addition, a local copy of the restricted list 328a may be stored on the mobile device 318c. To determine whether an individual is included on a restricted list 328, 328a the records of the restricted list(s) 328, 328a may be searched for at least some of the personal information 316 that was obtained by reading the barcode 304 on the individual's ID card 302.

In some embodiments, the additional function(s) that the barcode reading application 324 performs in the enhanced mode of operation may include determining auxiliary data 330 corresponding to the individual's participation or attempted participation in the age-restricted interaction. The auxiliary data 330 may be sent to one or more servers, such as a workflow server 323 and/or a data aggregation server 333. In some embodiments, the auxiliary data 330 may be stored and/or purged as required by law, as will be described in greater detail below.

There are many different kinds of auxiliary data 330 that may be determined and sent to a workflow server 323 and/or a data aggregation server 333 in accordance with the present disclosure. For example, consider embodiments where there is a defined minimum age requirement to enter an establishment and the age-related interaction with the establishment involves entering the establishment. In such embodiments, the auxiliary data 330 may include the date (and possibly also the specific time) when the individual entered the establishment.

As another example, consider embodiments where the establishment sells products that are associated with a minimum age requirement and the age-related interaction with the establishment involves purchasing such a product from the establishment. In such embodiments, the auxiliary data 330 may include purchase information indicating what product(s) the individual purchased from the establishment.

The workflow server 323 may collect auxiliary data 330 from the mobile device 318c and from other similar mobile devices. The workflow server 323 may use the auxiliary data 330 to create and maintain a customer interaction log 338 that includes information about age-restricted interactions between customers and one or more establishments. The customer interaction log 338 may include an entry log 340 that includes information about customers who have entered age-restricted establishments. The customer interaction log 338 may also include a purchase log 342 that includes information about customers who have purchased age-restricted products.

As indicated above, there may be legal regulations that govern the amount of time that the information in the customer interaction log 338 (including the entry log 340 and/or the purchase log 342) should be saved. For example, in some jurisdictions, certain information about age-restricted interactions between customers and establishments must be stored for a predetermined time duration, after which it must be purged (i.e., deleted so that the information is no longer saved). To comply with such legal regulations, the workflow server 323 is shown with a purging module 344. The purging module 344 may be configured to purge records from the customer interaction log 338 after a predetermined time duration (e.g., as required by legal regulations).

In addition, the workflow server 323 may also include some or all of the characteristics and/or functionality that was described above in connection with either of the workflow servers 23a-b in the system 10 shown in FIG. 1.

At least some auxiliary data 330 may also be sent to the data aggregation server 333. In some embodiments, the data aggregation server 333 may be configured to receive non-personally identifiable information (i.e., information that does not identify a specific person) about age-restricted interactions between individuals and a plurality of establishments. Some examples of non-personally identifiable information include a city, state, country, zip code, gender, date of purchase, and date of entry.

The data aggregation server 333 may also be configured to aggregate the non-personally identifiable information that it receives, thereby creating aggregated information. This aggregated information may be used to determine one or more metrics 348 related to age-restricted interactions between individuals and a plurality of establishments. The metric(s) 348 may be included in one or more statistical reports 350 that are provided by the data aggregation server 333.

In addition, the data aggregation server 333 may also include some or all of the characteristics and/or functionality that was described above in connection with either of the data aggregation servers 33a-b in the system 10 shown in FIG. 1.

The mobile device 318c may include any of the components that were described above in connection with the mobile device 18c that is shown in FIGS. 1 and 2. For example, the mobile device 318c may include one or more processors 44 and memory 46 in electronic communication with the one or more processors 44 (as shown in FIG. 2). The barcode reading application 324 may be stored in the memory 46. The barcode reading application 324 may be executable by the one or more processors 44 to implement the functionality that was described above in connection with the barcode reading application 324.

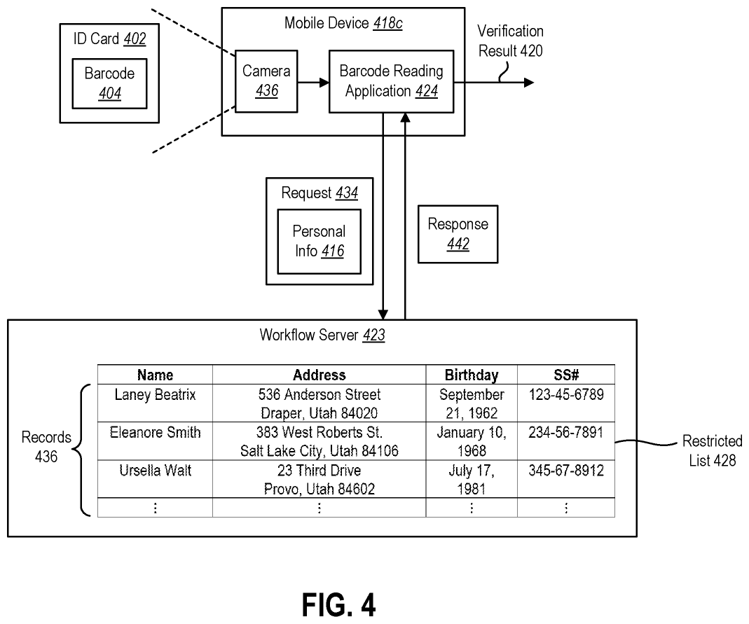

FIG. 4 illustrates an example of a restricted list 428. As indicated above, a restricted list 428 associated with an establishment may identify individuals who are to be denied entry to the establishment. Alternatively, or in addition, a restricted list 428 may identify individuals who are to be denied access to one or more products that are sold by the establishment. p The restricted list 428 shown in FIG. 4 includes a plurality of records 436. Each record 436 within the restricted list 428 may correspond to a particular individual. The record 436 associated with a particular individual may include personal information that may be useful for identifying that individual, such as the individual's name, address, birthday, social security number, etc.

FIG. 4 also illustrates an example of the types of communication that may occur between a mobile device 418c and a workflow server 423 in order to determine whether an individual is included on a restricted list 428. The mobile device 418c and the workflow server 423 shown in FIG. 4 may include some or all of the characteristics and/or functionality that were described above in connection with the mobile device 318c and the workflow server 323, respectively, shown in FIG. 3. For example, a camera 436 within the mobile device 418c may be used to capture an image of a barcode 404 on an ID card 402 associated with an individual. A barcode reading application 424 on the mobile device 418c may process the image to decode the barcode 404 and extract personal information 416 associated with the individual from the decoded data.

To determine whether the individual is included on the restricted list 428, the mobile device 418c may send a request 434 to the workflow server 423. The request 434 may include at least some of the personal information 416 that was obtained by reading the barcode 404 on the ID card 402 associated with the individual. For example, the request 434 may include the individual's name, address, birthday, social security number, etc.

In response to receiving the request 434, the workflow server 423 may search the records 436 of the restricted list 428 for at least some of the personal information 416 that was obtained by reading the barcode 404 on the individual's ID card 402. The workflow server 423 may send a response 442 to the mobile device 418c indicating the results of the search. If a match is found between the personal information 416 that is included in the request 434 and the information that is included in at least one of the records 436 within the restricted list 428, the response 442 to the mobile device 418c may indicate that the individual is included on the restricted list 428. If no match is found, however, then the response 442 may indicate that the individual is not included on the restricted list 428.

The verification result 420 that is output by the barcode reading application 424 may depend, at least in part, on the response 442 from the workflow server 423. If the response 442 from the workflow server 423 indicates that the individual is included on the restricted list 428, then the verification result 420 may indicate that the individual should be denied access to the establishment and/or access to one or more products sold by the establishment. If, however, the response 442 from the workflow server 423 indicates that the individual is not included on the restricted list 428, then the verification result 420 may indicate that the individual should be permitted to enter the establishment and/or to purchase one or more products sold by the establishment (subject to satisfying other requirements, such as a minimum age requirement).

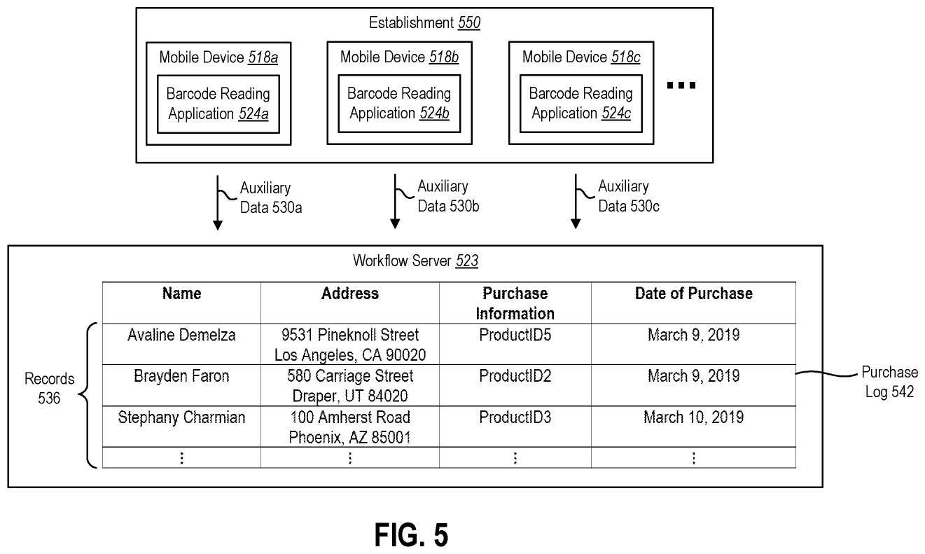

FIG. 5 illustrates an example of a purchase log 542 that may be created and maintained by a workflow server 523. As indicated above, the purchase log 542 may include information about customers who have purchased age-restricted products from one or more establishments.

The purchase log 542 shown in FIG. 5 includes a plurality of records 536. Each record 536 within the purchase log 542 may correspond to a particular purchase of an age-restricted product by an individual. The record 536 associated with a particular purchase may include identification information (e.g., name, address) corresponding to the individual who made the purchase, purchase information (e.g., product IDs) indicating what was purchased, and date information indicating the date when the purchase was made.

As indicated above, in some jurisdictions, certain information about age-restricted interactions between customers and establishments must be purged after a predetermined time duration. In embodiments where such regulations are in effect, the records 536 in the purchase log 542 may correspond to that predetermined time duration. For example, if applicable regulations specify that information about age-restricted interactions between customers and establishments must be purged after six months, then information in the purchase log 542 may correspond to purchases made during the most recent six months. Records 536 corresponding to older purchases may be purged from the purchase log 542.

FIG. 5 shows the workflow server 523 receiving auxiliary data 530a-c from a plurality of barcode reading applications 524a-c running on a plurality of different mobile devices 518a-c. The auxiliary data 530a-c may include information about purchases of age-restricted products (e.g., identification information, purchase information, date information) as described above. The workflow server 523 may create and update the purchase log 542 based on the auxiliary data 530a-c that it receives.

As shown in FIG. 5, the plurality of barcode reading applications 524a-c may correspond to a single establishment 550. For example, the establishment 550 may have several different entrances, and a different employee may be stationed at each of the entrances with one of the mobile devices 518a-c. In an alternative embodiment, the plurality of barcode reading applications 524a-c may correspond to a plurality of different establishments. In this case, each record 536 in the purchase log 542 may include a field that identifies a particular establishment that is the source of the information in the record 536.

In some embodiments, the workflow server 523 to which the mobile devices 518a-c corresponding to the establishment 550 send their auxiliary data 530a-c may be a dedicated workflow server 523 that is only used for mobile devices 518a-c corresponding to that particular establishment 550. Alternatively, the workflow server 523 may be used by a plurality of different establishments, each of which may have its own account on the workflow server 523.

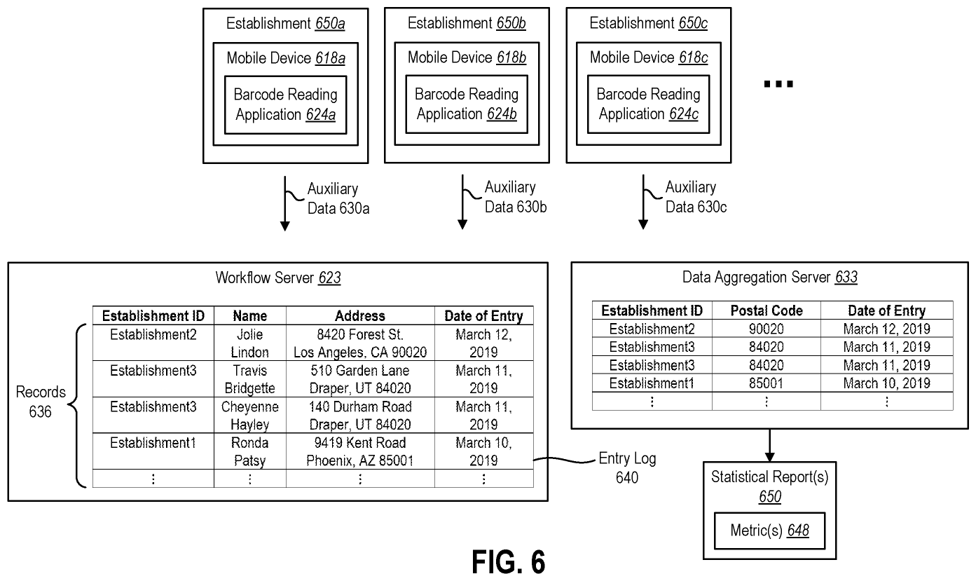

FIG. 6 illustrates an example of an entry log 640 that may be created and maintained by a workflow server 623. As indicated above, the entry log 640 may include information about customers who have entered age-restricted establishments.

The entry log 640 shown in FIG. 6 includes a plurality of records 636. Each record 636 within the entry log 640 may correspond to a particular entry event. As used herein, the term “entry event” refers to an event in which an individual enters an age-restricted establishment. The record 636 associated with a particular entry event may include identification information (e.g., name, address) corresponding to the individual who entered the age-restricted establishment as well as date information indicating the date (and possibly also the specific time) when the entry event occurred.

As indicated above, in some jurisdictions, certain information about age-restricted interactions between customers and establishments must be purged after a predetermined time duration. In embodiments where such regulations are in effect, the records 636 in the entry log 640 may correspond to that predetermined time duration. For example, if applicable regulations specify that information about age-restricted interactions between customers and establishments must be purged after six months, then information in the entry log 640 may correspond to entry events that occurred during the most recent six months. Records 636 corresponding to older entry events may be purged from the entry log 640.

FIG. 6 shows the workflow server 623 receiving auxiliary data 630a-c from a plurality of barcode reading applications 624a-c running on a plurality of different mobile devices 618a-c. The auxiliary data 630a-c may include the information about entry events that was described above (e.g., identification information, date information). The workflow server 623 may create and update the entry log 640 based on the auxiliary data 630a-c that it receives.

In the depicted example, the plurality of different mobile devices 618a-c correspond to a plurality of different establishments 650a-c. Each record 636 within the entry log 640 may include an establishment ID that identifies which of the establishments 650a-c provided the information in that record 636. Although the different mobile devices 618a-c correspond to different establishments 650ac, they may still send their auxiliary data 630a-c to the same workflow server 623. This may be the case, for example, if all of the establishments 650a-c have the same owner and that owner provides a common workflow server 623 for all of the establishments 650ac.

In some embodiments, the workflow server 623 to which the mobile devices 618a-c corresponding to the establishments 650a-c send their auxiliary data 630a-c may be a dedicated workflow server 623 that is only used for mobile devices 618ac corresponding to those particular establishments 650a-c (which may, for example, be commonly owned). Alternatively, the workflow server 623 may be used by a plurality of different establishments that may be owned by a plurality of different owners, each of which may have its own account on the workflow server 623.

FIG. 6 also shows at least some of the auxiliary data 630a-c from the different barcode reading applications 624a-c being sent to a data aggregation server 633. In particular, the non-personally identifiable information within the auxiliary data 630ac may be sent to the data aggregation server 633. For example, if the auxiliary data 630ac that is sent to the workflow server 623 includes an individual's address, the non-personally identifiable portion of the address (e.g., the city, state, and zip code) may be sent to the data aggregation server 633. Some other examples of non-personally identifiable information associated with entry events include date of entry, time of entry, the entrant's gender, the entrant's age, and an establishment ID.

FIG. 6 shows non-personally identifiable information within the entry log 640 being sent to the data aggregation server 633. Alternatively, or in addition, non-personally identifiable information within a purchase log (e.g., the purchase log 542 shown in FIG. 5) may also be sent to the data aggregation server 633. Some examples of non-personally identifiable information associated with the purchase of age-restricted products include product(s) purchased, date of purchase, time of purchase, the purchaser's gender, the purchaser's age, the non-personally identifiable portion of the purchaser's address (e.g., the city, state, and zip code), and an establishment ID.

The data aggregation server 633 may also be configured to aggregate the non-personally identifiable information that it receives, thereby creating aggregated information. This aggregated information may be used to determine one or more metrics 648 related to age-restricted interactions between individuals and a plurality of establishments. The metrics 648 may be included in one or more statistical reports 650 that are provided by the data aggregation server 633. The statistical reports 650 may include visual representations of the metrics 648.

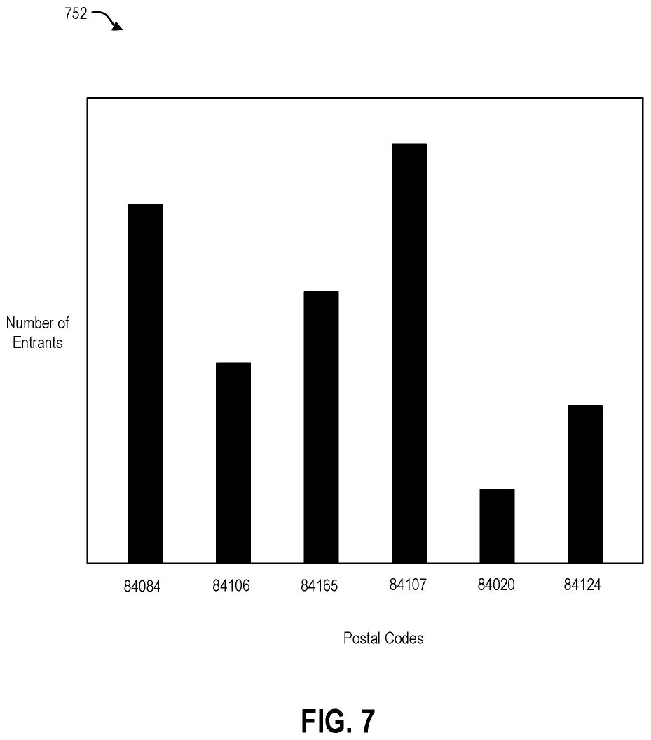

There are many different types of metrics 648 that may be determined in accordance with the present disclosure. As just one example, the data aggregation server 633 may determine the number of entry events (or purchases of age-restricted products) that have occurred over a particular period of time, sorted by some characteristic of the entry event (or product purchase). FIG. 7 illustrates a visual representation of this type of metric 648, in the form of a bar graph 752. The depicted bar graph 752 illustrates the number of entry events that have occurred over a particular period of time, sorted by zip code. This type of bar graph 752 makes it simple for someone to quickly and easily see where the patrons of an establishment live. Similar bar graphs (or other types of visual representations) may be produced for other types of metrics associated with entry events or product purchases.

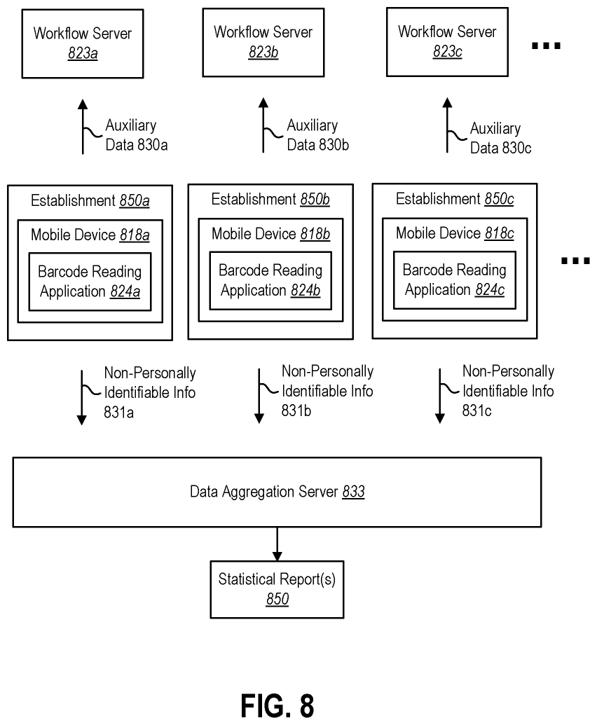

FIG. 8 illustrates an example in which a plurality of barcode reading applications 824a-c are running on a plurality of different mobile devices 818ac. The plurality of different mobile devices 818a-c may correspond to a plurality of different establishments 850ac. The mobile devices 818a-c send auxiliary data 830a-c to different workflow servers 823ac.

In the depicted example, some of the auxiliary data 830a-c (e.g., the non-personally identifiable information 831a-c within the auxiliary data 830ac) from the plurality of workflow servers 823a-c may be aggregated by a data aggregation server 833. In other words, although in the depicted example each of the workflow servers 823a-c receives auxiliary data 830a-c from just one of the establishments 850ac, the data aggregation server 833 receives the non-personally identifiable information 83 lac within the auxiliary data 830a-c from all of the establishments 850ac. Thus, the data aggregation server 833 aggregates data across a broader spectrum of establishments 850a-c than the workflow servers 823ac. In other words, the auxiliary data 830a-c from the plurality of establishments 850a-c may essentially be pooled for purposes of the data aggregation that is performed by the data aggregation server 833.

The statistical reports 850 that are provided by the data aggregation server 833 may be made available to any of the establishments 850a-c that provided part of the auxiliary data 830a-c that was used to create the statistical reports 850 (and/or that paid fees to receive the statistical reports 850).

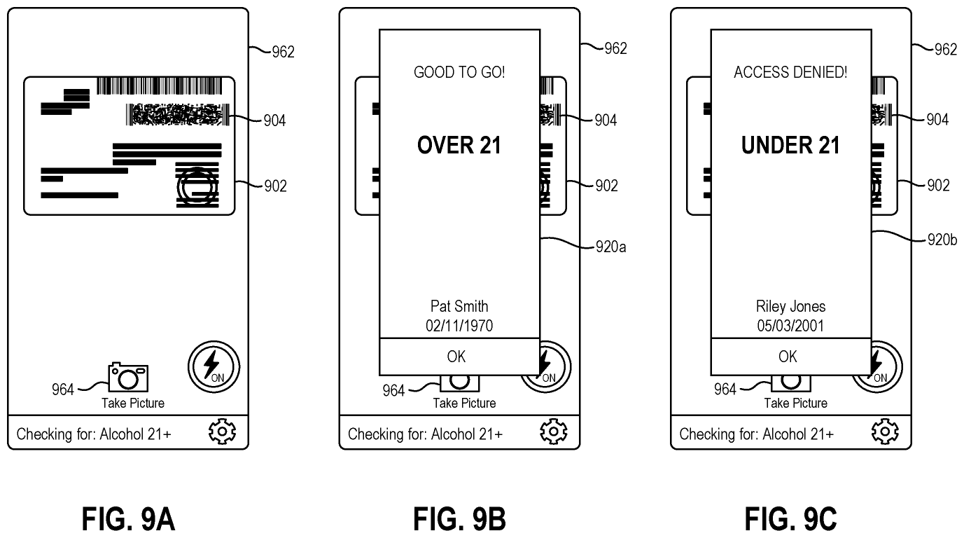

FIGS. 9A-C illustrate an example of a user interface 962 that may be displayed by a barcode reading application 324 on a mobile device 318c in accordance with the present disclosure. As discussed above, the mobile device 318c includes a camera 336. FIG. 9A illustrates the user interface 962 at a point in time when an ID card 902 associated with an individual is positioned within the field of view of the camera 336. The ID card 902 includes a barcode 904. As discussed above, the barcode 904 represents an encoded representation of certain information. The information that is encoded into the barcode 904 may include certain personal information (including but not limited to the individual's birthday) about the individual who is associated with the ID card 902.

As discussed above, the mobile device 318c may include a camera 336, and the barcode reading application 324 on the mobile device 318c may cause the camera 336 to capture an image 306 that includes the barcode 904 on the ID card 902. This image 306 may be captured in response to input provided by a user of the mobile device 318c. The user interface 962 may include a user interface element 964 that permits the user to provide such input. If the mobile device 318c includes a touchscreen display and the user interface 962 is displayed on the touchscreen display, then the user may press the user interface element 964 with his or her finger to cause the camera 336 to capture the image 306. Alternatively, the barcode reading application 324 may be configured to automatically (i.e., without user input) cause the camera 336 to capture the image 306 as soon as a barcode 904 is detected within the field of view of the camera 336.

FIG. 9B illustrates the user interface 962 at a point in time that is subsequent to the point in time shown in FIG. 9A. In the example shown in FIG. 9B, it is assumed that the verification engine 318 has determined, using personal information 316 extracted from the barcode 904, that the individual satisfies the minimum age requirement. Consequently, the user interface 962 displays a positive verification result 920a indicating that the individual should be permitted to participate in the age-related interaction with the establishment.

FIG. 9C also illustrates the user interface 962 at a point in time that is subsequent to the point in time shown in FIG. 9A. In the example shown in FIG. 9C, however, it is assumed that the verification engine 318 has determined that the individual does not satisfy the minimum age requirement. Consequently, the user interface 962 displays a negative verification result 920b indicating that the individual should not be permitted to participate in the age-related interaction with the establishment.

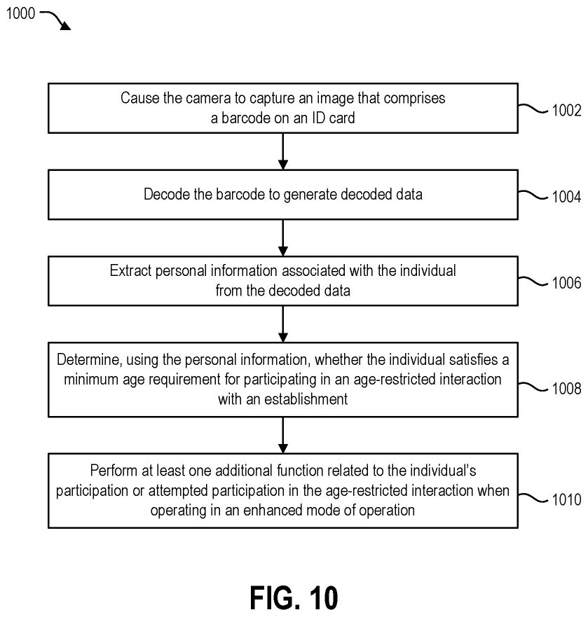

In some embodiments, the type of verification result that is displayed (a positive verification result 920a or a negative verification result 920b) may depend on both age verification and also the restricted list 328. This will be described in greater detail below in connection with FIG. 10A.

FIG. 10 illustrates an example of a method 1000 that may be implemented by a barcode-reading application 324 running on a mobile device 318c in accordance with the present disclosure. The method 1000 will be described in relation to some of the systems, devices, components, and data described previously.

Step 1002 involves causing the camera 336 of the mobile device 318c to capture an image 306 that comprises a barcode 304 on an ID card 302 corresponding to an individual.

Step 1004 involves decoding the barcode 304 to generate decoded data 312. Step 1006 involves extracting personal information 316 associated with the individual from the decoded data 312.

Step 1008 involves determining, using the personal information 316, whether the individual satisfies a minimum age requirement for participating in an age-restricted interaction with an establishment. If the barcode reading application 324 determines that the individual satisfies the age requirement, then the barcode reading application 324 may output a positive verification result 920a indicating that the individual should be permitted to participate in the age-restricted interaction with the establishment. If, however, the barcode reading application 324 determines that the individual does not satisfy the age requirement, then the barcode reading application 324 may output a negative verification result 920b indicating that the individual should not be permitted to participate in the age-restricted interaction with the establishment.

Step 1010 involves performing at least one additional function related to the individual's participation or attempted participation in the age-restricted interaction when operating in an enhanced mode of operation.

In some embodiments, the at least one additional function that is performed in step 1010 may comprise using the personal information 316 to determine whether the individual is included on a restricted list 328 that identifies individuals who are to be denied access to the establishment. The restricted list 328 may be stored on a server, such as a workflow server 323. Determining whether the individual is included on the restricted list 328 may involve sending a request 434 to the server. The request 434 may include at least some of the personal information 316 that was obtained by reading the barcode 304 on the ID card 302 associated with the individual.

Alternatively, or in addition, a local copy of the restricted list 328a may be stored on the mobile device 318c. Determining whether the individual is included on the restricted list 328 may involve searching records within the local copy of the restricted list 328a for at least some of the personal information 316 that was obtained by reading the barcode 304 on the ID card 302 associated with the individual.

In some embodiments, the at least one additional function that is performed in step 1010 may comprise determining auxiliary data 330 corresponding to the individual's participation or attempted participation in the age-restricted interaction with the establishment and sending the auxiliary data 330 to a server (e.g., a workflow server 323 and/or a data aggregation server 333).

In some embodiments, there may be a minimum age requirement defined for the establishment, and the age-restricted interaction with the establishment may involve entering the establishment. In such embodiments, the auxiliary data 330 may comprise date information indicating a date when the individual entered the establishment.

In some embodiments, the establishment may sell products that are associated with a minimum age requirement, and the age-restricted interaction with the establishment may involve purchasing an age-restricted product from the establishment. In such embodiments, the auxiliary data 330 may comprise purchase information indicating what the individual purchased from the establishment.

In some embodiments, the barcode reading application 324 may require a license key 326 to operate in the enhanced mode of operation. The barcode reading application 324 may download the license key 326 from a license server (e.g., one of the license servers 21a-b in the system 10 shown in FIG. 1).

FIG. 10A illustrates another example of a method 1000A that may be implemented by a barcode-reading application 324 running on a mobile device 318c in accordance with the present disclosure. The method 1000A will be described in relation to some of the systems, devices, components, and data described previously. In the depicted method 1000A, the verification result 320 provided by the barcode reading application depends on both age verification and also the restricted list 328.

Steps 1002A through 1008A of the method 1000A are similar to steps 1002 through 1008 of the method 1000 shown in FIG. 10. In particular, step 1002A involves causing the camera 336 of the mobile device 318c to capture an image 306 that comprises a barcode 304 on an ID card 302 corresponding to an individual. Step 1004A involves decoding the barcode 304 to generate decoded data 312. Step 1006A involves extracting personal information 316 associated with the individual from the decoded data 312. Step 1008A involves determining, using the personal information 316, whether the individual satisfies a minimum age requirement for participating in an age-restricted interaction with an establishment.

If in step 1008A the barcode reading application 324 determines that the individual does not satisfy the age requirement, then in step 1010A the barcode reading application 324 outputs a negative verification result 920b indicating that the individual should not be permitted to participate in the age-restricted interaction with the establishment.

If, however, in step 1008A the barcode reading application 324 determines that the individual satisfies the age requirement, then in step 1012A the barcode reading application 324 determines, using the personal information 316, whether the individual is located on a restricted list 328. In embodiments where the restricted list 328 is located on a server (e.g., a workflow server 323) that is separate from the mobile device 318c, step 1012A may involve sending a request 434 to the server and receiving a response 442 from the server. Alternatively, or in addition, step 1012A may involve searching a local copy of the restricted list 328a for some or all of the personal information 316 that was obtained by reading the barcode 304 on the individual's ID card 302.

If in step 1012A the barcode reading application 324 determines that the individual is on a restricted list 328, then in step 1010A the barcode reading application 324 outputs a negative verification result 920b indicating that the individual should not be permitted to participate in the age-restricted interaction with the establishment.

If, however, in step 1012A the barcode reading application 324 determines that the individual is not on a restricted list 328, then in step 1014A the barcode reading application 324 outputs a positive verification result 920a indicating that the individual should be permitted to participate in the age-restricted interaction with the establishment.

The order of the verification operations shown in FIG. 10A is provided for purposes of example only and should not be interpreted as limiting the scope of the present disclosure. In an alternative embodiment, the barcode reading application 324 may initially determine whether an individual is on a restricted list 328. If it is determined that the individual is not on the restricted list 328, then the barcode reading application 324 may subsequently perform age verification.

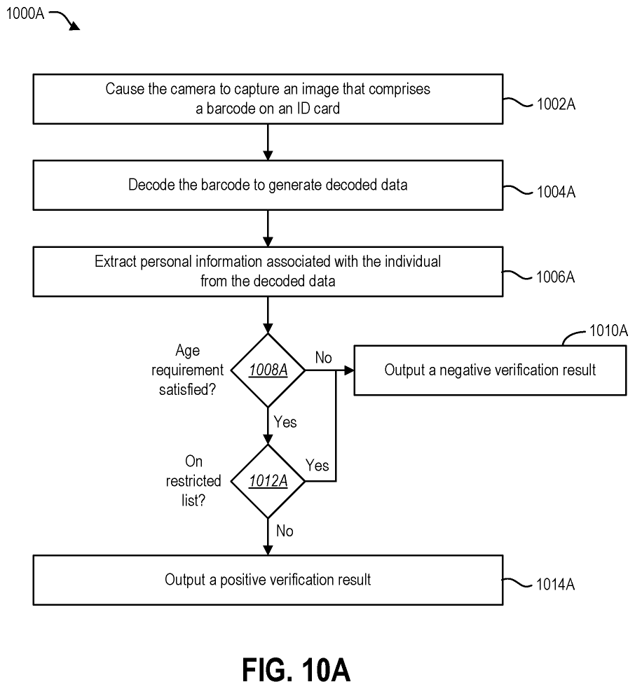

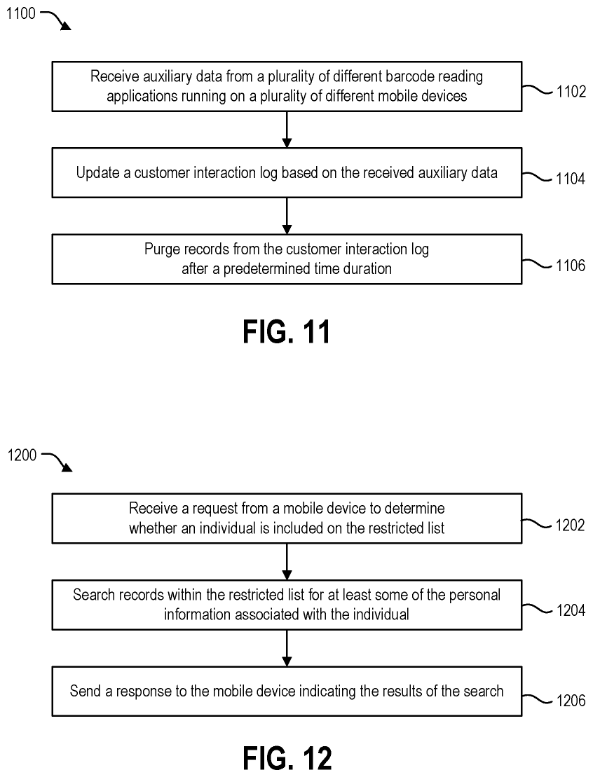

FIGS. 11 and 12 illustrate methods 1100, 1200 that may be implemented by a workflow server 323 in accordance with the present disclosure. The methods 1100, 1200 will be described in relation to some of the systems, devices, components, and data described previously.

The method 1100 shown in FIG. 11 will be discussed initially. This method 1100 is related to handling auxiliary data 330. Step 1102 involves receiving auxiliary data 330. The auxiliary data 330 may be received from a plurality of different barcode reading applications 624a-c running on a plurality of different mobile devices 618ac. In some embodiments, at least some of the plurality of barcode reading applications 624a-c may correspond to different establishments 650ac.

Step 1104 involves updating a customer interaction log 338 (including an entry log 340 and/or a purchase log 342) based on the received auxiliary data 330. In embodiments where at least some of the plurality of barcode reading applications 624acfrom which auxiliary data 330 is received correspond to different establishments 650ac, records within the customer interaction log 338 may include an establishment ID.

As indicated above, in some jurisdictions, certain information about age-restricted interactions between customers and establishments must be purged after a predetermined time duration. In embodiments where such regulations are in effect, step 1106 involves purging records from the customer interaction log 338 after the predetermined time duration.

The method 1200 shown in FIG. 12 is related to managing a restricted list 328. Step 1202 involves receiving a request 434 from a mobile device 318c to determine whether an individual is included on the restricted list 328. The request 434 may include personal information 416 associated with the individual. Step 1204 involves searching records 436 within the restricted list 328 for at least some of the personal information 416 associated with the individual. Step 1206 involves sending a response 442 to the mobile device 318c indicating the results of the search. If a match is found between the personal information 316 that is included in the request 434 and the information that is included in at least one of the records 436 within the restricted list 328, the response 442 to the mobile device 318c may indicate that the individual is included on the restricted list 328. If no match is found, however, then the response 442 may indicate that the individual is not included on the restricted list 328.

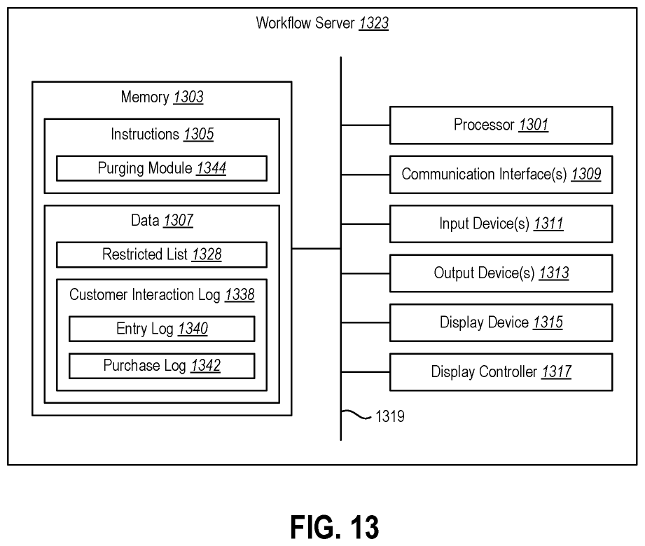

FIG. 13 illustrates certain components that may be included within a workflow server 1323 in accordance with the present disclosure.

The workflow server 1323 includes a processor 1301. The processor 1301 may be a general purpose single- or multi-chip microprocessor (e.g., an Advanced RISC (Reduced Instruction Set Computer) Machine (ARM)), a special purpose microprocessor (e.g., a digital signal processor (DSP)), a microcontroller, a programmable gate array, etc. The processor 1301 may be referred to as a central processing unit (CPU). Although just a single processor 1301 is shown in the workflow server 1323 of FIG. 13, in an alternative configuration, a combination of processors (e.g., an ARM and DSP) could be used.

The workflow server 1323 also includes memory 1303 in electronic communication with the processor 1301. The memory 1303 may be any electronic component capable of storing electronic information. For example, the memory 1303 may be embodied as random access memory (RAM), read-only memory (ROM), magnetic disk storage media, optical storage media, flash memory devices in RAM, on-board memory included with the processor 1301, erasable programmable read-only memory (EPROM), electrically erasable programmable read-only memory (EEPROM) memory, registers, and so forth, including combinations thereof.

Instructions 1305 and data 1307 may be stored in the memory 1303. The instructions 1305 may be executable by the processor 1301 to implement some or all of the steps, operations, actions, or other functionality disclosed herein. For example, the instructions 1305 may be executable by the processor 1301 to implement the methods 1100, 1200 shown in FIGS. 11 and 12. Executing the instructions 1305 may involve the use of the data 1307 that is stored in the memory 1303. Unless otherwise specified, any of the various examples of modules and components described herein may be implemented, partially or wholly, as instructions 1305 stored in memory 1303 and executed by the processor 1301. Any of the various examples of data described herein may be among the data 1307 that is stored in memory 1303 and used during execution of the instructions 1305 by the processor 1301.

The instructions 1305 in the memory 1303 may include a purging module 1344. The data 1307 in the memory 1303 may include a restricted list 1328 and a customer interaction log 1338. The restricted list 1328 may identify individuals who are to be denied at least one of (i) entry to one or more establishments, or (ii) access to one or more products that are sold by one or more establishments. The customer interaction log 1338 may include information about age-restricted interactions between customers and one or more establishments. The customer interaction log 1338 may include an entry log 1340 and/or a purchase log 1342. The entry log 1340 may include identification information for individuals who have entered the establishment as well as date information indicating when the individuals entered the establishment. The purchase log 1342 may include identification information corresponding to individuals who have purchased age-restricted products from the establishment as well as purchase information indicating what the individuals purchased from the establishment.

As indicated above, in some jurisdictions, certain information about age-restricted interactions between customers and establishments must be purged after a predetermined time duration. In embodiments where such regulations are in effect, the records in the entry log 1340 and/or the purchase log 1342 may be those records that were generated during a most recent time period corresponding to the predetermined time duration. Older records may be purged.

The specific examples of instructions 1305 and data 1307 shown in FIG. 13 may include any of the characteristics of the similarly named items described previously. For example, the purging module 1344 may include any of the characteristics of the purging module 344 described previously. The restricted list 1328 may include any of the characteristics of the restricted lists 328, 428 described previously. The customer interaction log 1338 may include any of the characteristics of the customer interaction log 338 described previously. The entry log 1340 may include any of the characteristics of the entry logs 340, 640 described previously. The purchase log 1342 may include any of the characteristics of the purchase logs 342, 542 described previously.

The workflow server 1323 may also include one or more communication interfaces 1309 for communicating with other electronic devices. The communication interface(s) 1309 may be based on wired communication technology, wireless communication technology, or both. Some examples of communication interfaces 1309 include a Universal Serial Bus (USB), an Ethernet adapter, a wireless adapter that operates in accordance with an Institute of Electrical and Electronics Engineers (IEEE) 802.13 wireless communication protocol, a Bluetooth® wireless communication adapter, and an infrared (IR) communication port.

A workflow server 1323 may also include one or more input devices 1313 and one or more output devices 1313. Some examples of input devices 1313 include a keyboard, mouse, microphone, remote control device, button, joystick, trackball, touchpad, and lightpen. One specific type of output device 1313 that is typically included in a workflow server 1323 is a display device 1315. Display devices 1315 used with embodiments disclosed herein may utilize any suitable image projection technology, such as liquid crystal display (LCD), light-emitting diode (LED), gas plasma, electroluminescence, or the like. A display controller 1317 may also be provided, for converting data 1307 stored in the memory 1303 into text, graphics, and/or moving images (as appropriate) shown on the display device 1315. The workflow server 1323 may also include other types of output devices 1313, such as a speaker, a printer, etc.

The various components of the workflow server 1323 may be coupled together by one or more buses, which may include a power bus, a control signal bus, a status signal bus, a data bus, etc. For the sake of clarity, the various buses are illustrated in FIG. 13 as a bus system 1319.

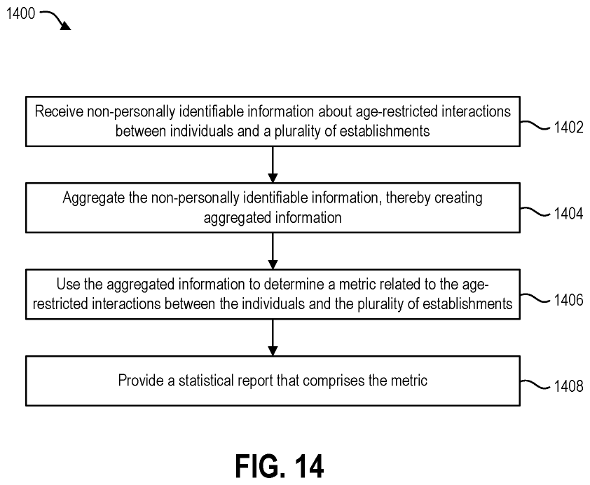

FIG. 14 illustrates a method 1400 that may be implemented by a data aggregation server 333 in accordance with the present disclosure. The method 1400 will be described in relation to some of the systems, devices, components, and data described previously.

Step 1402 involves receiving non-personally identifiable information 831acabout age-restricted interactions between individuals and a plurality of establishments. The non-personally identifiable information 831a-c about the age-restricted interactions may be received from a plurality of barcode reading applications 824a-c running on a plurality of different mobile devices 818ac. At least some of the plurality of barcode reading applications 824a-c may correspond to different establishments 850ac.

Step 1404 involves aggregating the non-personally identifiable information 831 ac, thereby creating aggregated information. Step 1406 involves using the aggregated information to determine one or more metrics 348 related to the age-restricted interactions between the individuals and the plurality of establishments. Step 1408 involves providing one or more statistical reports 350 that comprise the metric(s) 348. The statistical report(s) 350 may comprise a visual representation of the metric(s) 348.

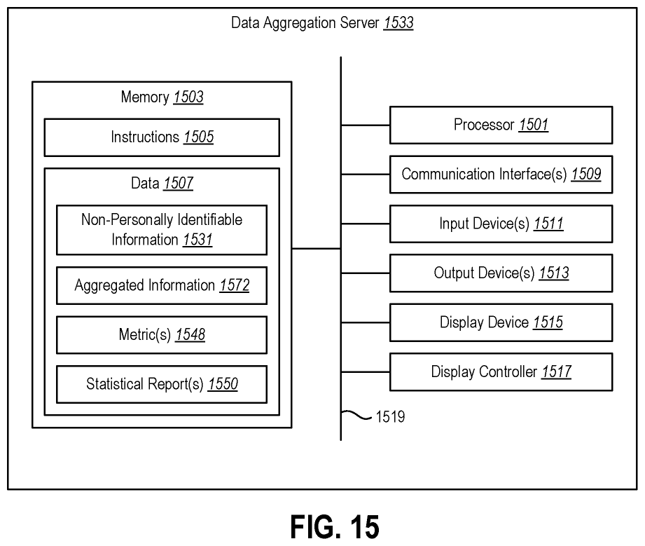

FIG. 15 illustrates certain components that may be included within a data aggregation server 1533 in accordance with the present disclosure.

The data aggregation server 1533 includes a processor 1501, memory 1503 in electronic communication with the processor 1501, instructions 1505 and data 1507 stored in the memory 1503, one or more communication interfaces 1509, one or more input devices 1511, one or more output devices 1513, a display device 1515, a display controller 1517, and a system bus 1519. These components may include any of the characteristics that were described above in connection with the similar components in the workflow server 1323.

The instructions 1505 may be executable by the processor 1501 to implement some or all of the steps, operations, actions, or other functionality that is disclosed herein in connection with the data aggregation server 1533. For example, the instructions 1505 may be executable by the processor 1501 to implement the method 1400 shown in FIG. 14.

Executing the instructions 1505 may involve the use of the data 1507 that is stored in the memory 1503. The data 1507 may include non-personally identifiable information 1531, which may be similar to the non-personally identifiable information 831a-c described previously. The data 1507 may also include aggregated information 1572. The instructions 1505 may be executable by the processor(s) 1501 to aggregate the non-personally identifiable information 1531, thereby creating the aggregated information 1572. The data 1507 may also include one or more metrics 1548 related to age-restricted interactions between individuals and a plurality of establishments. The aggregated information 1572 may be used to determine the metric(s) 1548. The metric(s) 1548 may be similar to the metrics 348, 648 described previously. The data 1507 may also include one or more statistical reports 1550 that comprise the metric(s) 1548. The statistical report(s) 1550 may be similar to the statistical reports 350, 650, 850 described previously.

The techniques described herein may be implemented in hardware, software, firmware, or any combination thereof, unless specifically described as being implemented in a specific manner. Any features described as modules, components, or the like may also be implemented together in an integrated logic device or separately as discrete but interoperable logic devices. If implemented in software, the techniques may be realized at least in part by a non-transitory computer-readable medium having computer-executable instructions stored thereon that, when executed by at least one processor, perform some or all of the steps, operations, actions, or other functionality disclosed herein. The instructions may be organized into routines, programs, objects, components, data structures, etc., which may perform particular tasks and/or implement particular data types, and which may be combined or distributed as desired in various embodiments.

The steps, operations, and/or actions of the methods described herein may be interchanged with one another without departing from the scope of the claims. In other words, unless a specific order of steps, operations, and/or actions is required for proper functioning of the method that is being described, the order and/or use of specific steps, operations, and/or actions may be modified without departing from the scope of the claims.

The term “determining” (and grammatical variants thereof) encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. For example, any element or feature described in relation to an embodiment herein may be combinable with any element or feature of any other embodiment described herein, where compatible.

The present disclosure may be embodied in other specific forms without departing from its spirit or characteristics. The described embodiments are to be considered as illustrative and not restrictive. The scope of the disclosure is, therefore, indicated by the appended claims rather than by the foregoing description. Changes that come within the meaning and range of equivalency of the claims are to be embraced within their scope.

What is claimed is:

1. A mobile device, comprising:
a camera;
one or more processors;
memory in electronic communication with the one or more processors; and
a barcode reading application stored in the memory, the barcode reading application being executable by the one or more processors to:
cause the camera to capture an image that comprises a barcode on an identification (ID) card corresponding to an individual;
decode the barcode to generate decoded data;
extract personal information associated with the individual from the decoded data;
determine, using the personal information, whether the individual satisfies a minimum age requirement for participating in an age-restricted interaction with an establishment; and
perform at least one additional function related to the individual's participation or attempted participation in the age-restricted interaction when operating in an enhanced mode of operation.

2. The mobile device of claim 1, wherein the at least one additional function comprises using the personal information to determine whether the individual is included on a restricted list that identifies individuals who are to be denied access to the establishment.

3. The mobile device of claim 2, wherein:
the restricted list is stored on a server; and
determining whether the individual is included on the restricted list comprises sending a request to the server, the request comprising at least some of the personal information that was obtained by reading the barcode on the ID card associated with the individual.

4. The mobile device of claim 2, wherein:
a local copy of the restricted list is stored on the mobile device; and
determining whether the individual is included on the restricted list comprises searching records within the local copy of the restricted list for at least some of the personal information that was obtained by reading the barcode on the ID card associated with the individual.

5. The mobile device of claim 1, wherein the at least one additional function comprises:
determining auxiliary data corresponding to the individual's participation or attempted participation in the age-restricted interaction; and
sending the auxiliary data to a server.

6. The mobile device of claim 5, wherein:
the age-restricted interaction with the establishment comprises entering the establishment; and
the auxiliary data comprises date information indicating a date when the individual entered the establishment.

7. The mobile device of claim 5, wherein:
the establishment sells products that are associated with a minimum age requirement;
the age-restricted interaction with the establishment comprises purchasing an age-restricted product from the establishment; and
the auxiliary data comprises purchase information indicating what the individual purchased from the establishment.

8. The mobile device of claim 1, wherein:
the barcode reading application requires a license key to operate in the enhanced mode of operation; and
the barcode reading application is also executable by the one or more processors to download the license key from a license server.

9. The mobile device of claim 1, wherein the barcode reading application is also executable by the one or more processors to:
determine that the individual satisfies the age requirement; and
output a positive verification result indicating that the individual should be permitted to participate in the age-restricted interaction with the establishment.

10. The mobile device of claim 1, wherein the barcode reading application is also executable by the one or more processors to:
determine that the individual does not satisfy the age requirement; and
output a negative verification result indicating that the individual should not be permitted to participate in the age-restricted interaction with the establishment.

11. A workflow server, comprising:
one or more processors;
memory in electronic communication with the one or more processors;
a customer interaction log stored in the memory that comprises information about age-restricted interactions between customers and an establishment;
a restricted list stored in the memory, wherein the restricted list identifies individuals who are to be denied access to the establishment; and
instructions stored in the memory, the instructions being executable by the one or more processors to purge records from the customer interaction log after a predetermined time duration.

12. The workflow server of claim 11, wherein the customer interaction log comprises an entry log that includes:
identification information for individuals who have entered the establishment during a most recent time period corresponding to the predetermined time duration; and
date information indicating when the individuals entered the establishment.

13. The workflow server of claim 11, wherein the customer interaction log comprises a purchase log that includes:
identification information corresponding to individuals who have purchased age-restricted products from the establishment during a most recent time period corresponding to the predetermined time duration; and
purchase information indicating what the individuals purchased from the establishment.

14. The workflow server of claim 11, wherein the restricted list identifies individuals who are to be denied at least one of entry to the establishment or access to one or more products that are sold by the establishment.

15. The workflow server of claim 11, wherein the instructions are also executable by the one or more processors to:
receive auxiliary data from a plurality of different barcode reading applications running on a plurality of different mobile devices; and
update the customer interaction log based on the received auxiliary data.

16. The workflow server of claim 15, wherein:
at least some of the plurality of barcode reading applications correspond to different establishments; and
records within the customer interaction log comprise an establishment identifier.

17. The workflow server of claim 11, wherein the instructions are also executable by the one or more processors to:
receive a request from a mobile device to determine whether an individual is included on the restricted list, wherein the request comprises personal information associated with the individual;
search records within the restricted list for at least some of the personal information associated with the individual; and
send a response to the mobile device indicating results of the search.

18. A data aggregation server, comprising:
one or more processors;
memory in electronic communication with the one or more processors; and
instructions stored in the memory, the instructions being executable by the one or more processors to:
receive non-personally identifiable information about age-restricted interactions between individuals and a plurality of establishments;
aggregate the non-personally identifiable information, thereby creating aggregated information;
use the aggregated information to determine a metric related to the age-restricted interactions between the individuals and the plurality of establishments; and
provide a statistical report that comprises the metric.

19. The data aggregation server of claim 18, wherein:
the non-personally identifiable information about the age-restricted interactions is received from a plurality of barcode reading applications on a plurality of different mobile devices; and
at least some of the plurality of different barcode reading applications correspond to different establishments.

20. The data aggregation server of claim 18, wherein the statistical report comprises a visual representation of the metric.
